(19) United States
(12) Patent Application Publication
(10) Pub. No.: US 2015/0222935 A1
(43) Pub. Date: Aug. 6, 2015

(54) VENUE SPECIFIC MULTI POINT IMAGE CAPTURE

(71) Applicant: LiveStageº, Inc., New York, NY (US)

(72) Inventors: Kristopher King, Hermosa Beach, CA (US); Jeff Prosserman, New York, NY (US)

(73) Assignee: LIVESTAGEÂ°, INC., New York, NY (US)

(21) Appl. No.: 14/687,752

(22) Filed: Apr. 15, 2015

Related U.S. Application Data
(63) Continuation-in-part of application No. 14/532,659, filed on Nov. 4, 2014.
(60) Provisional application No. 61/981,416, filed on Apr. 18, 2014.
(60) Provisional application No. 61/900,093, filed on Nov. 5, 2013.

(51) Int. Cl. H04N 21/218; H04N 21/242; H04N 21/2187; H04N 21/2365; H04N 5/265; H04N 13/00

(52) U.S. Cl. CPC H04N 21/21805; H04N 5/265; H04N 13/004; H04N 21/2187; H04N 21/2365; H04N 21/242

(57) ABSTRACT

The present invention provides methods and apparatus for designing image capture orientations for specific performance venues and manners of presenting designs for image capture at specific venues.

### CROSS REFERENCE TO RELATED APPLICATION

This application claims the benefit of the U.S. Provisional Application Ser. No. 61/981,416 filed on Apr. 18, 2014. This application claims priority to the U.S. Non-Provisional patent application Ser. No. 14/532,659, filed on Nov. 4, 2014 and entitled SWITCHABLE MULTIPLE VIDEO TRACK PLATFORM as a Continuation in Part patent application. The application Ser. No. 14/532,659 claims the benefit of the U.S. Provisional Application Ser. No. 61/900,093 filed on Nov. 5, 2013. The contents of each are relied upon and hereby incorporated by reference.

### FIELD OF THE INVENTION

The present invention relates to methods and apparatus for generating streaming video captured from multiple vantage points. More specifically, the present invention presents methods and apparatus for the process of designing the placement of apparatus for capturing image data in two dimensional or three dimensional data formats and from multiple disparate points of capture based on venue specific characteristics, wherein the assembling of the captured image data into a viewing experience may emulating observance of an event from at least two of the multiple points of capture in specifically chosen locations of a particular venue.

### BACKGROUND OF THE INVENTION

Traditional methods of viewing image data generally include viewing a video stream of images in a sequential format. The viewer is presented with image data from a single vantage point at a time. Simple video includes streaming of imagery captured from a single image data capture device, such as a video camera. More sophisticated productions include sequential viewing of image data captured from more than one vantage point and may include viewing image data captured from more than one image data capture device.

As video capture has proliferated, popular video viewing forums, such as YouTube™, have arisen to allow for users to choose from a variety of video segments. In many cases, a single event will be captured on video by more than one user and each user will post a video segment on YouTube. Consequently, it is possible for a viewer to view a single event from different vantage points, However, in each instance of the prior art, a viewer must watch a video segment from the perspective of the video capture device, and cannot switch between views in a synchronized fashion during video replay. As well, the location of the viewing positions may in general be collected in a relatively random fashion from positions in a particular venue where video was collected and made available ad hoc.

Consequently, alternative ways of proactively designing specific location patterns for the collection of image data that may be combined and processed into a collection of venue specific video segments that may subsequently be controlled by a viewer are desirable.

### SUMMARY OF THE INVENTION

Accordingly, the present invention provides methods and apparatus for designing specific location patterns for the collection of image data in a venue specific manner.

The image data captured from multiple vantage points may be captured as one or both of: two dimensional image data or three dimensional image data. The data is synchronized such that a user may view image data from multiple vantage points, each vantage point being associated with a disparate image capture device. The data is synchronized such that the user may view image data of an event or subject at an instance in time, or during a specific time sequence, from one or more vantage points.

In some embodiments, locations of image capture apparatus may be designed in a venue specific manner based on the design aspects of a particular venue and the stage setting that is placed within the venue. It may be desirable to provide a user with multiple image capture sequences from different locations in the particular venue. One or more of stage level, back stage, orchestra, balcony and standard named locations may be included in the set of locations for image capture apparatus. It may also be desirable to select design locations for image capture based upon a view path from a particular location to a desired focal perspective such as a typical location for a performer or participant, the location of performing equipment or a focal point for activity of a performer or performers. In other embodiments, the location of design locations may relate to a desired focal perspective relating to locations of spectators at an event.

In some exemplary embodiments, the designed locations of the image capture apparatus may be superimposed upon a spatial representation of a specific venue. Characteristics of the location including, the type of image capture device at the location, a positional reference relating to a seating reference in seating zones, or spatial parameters including distances, heights and directional information may also be presented to a user upon the superimposed spatial representation. In some embodiments, the spatial representation or virtual representation may include depictions of designed locations superimposed upon graphic representations of a venue and may be presented to a user upon a graphical display apparatus of a workstation.

In some embodiments, the virtual representation may include graphical depictions of the view that may be observed from a design location. The virtual representation may include a line of sight depiction to a focal point in the venue, or in other embodiments may allow for a flexible representation of a typical view in a set of different directional vectors from a design point. In other embodiments, the virtual representation may be chosen from a user selectable spectrum of directional possibilities. The virtual representation may in some embodiments include computer generated simulations of the view. In other embodiments, actual image data may be used to provide the virtual representation of the view from a design location.

In additional embodiments, the specific placement of image capture apparatus within a zonal region of a venue may be influenced by venue specific characteristic including but not limited to the shape and other characteristics of zones for spectators such as seating arrangement in the zone. In some embodiments, the location of obstructions such as columns, speakers, railings, and other venue specific aspects may influence the design for placement of image capture apparatus. In other embodiments, the location of viewpoints that are not typically accessible to spectators may be included in the design of venue specific image capture device placement.

In some embodiments, the placement of designed locations for image capture devices may be based upon venue specific historical data. The venue specific historical data may include the historical demand for a seating location. The demand may relate to rapidity that a location is purchased for a typical class of performances, the frequency of occupation of a particular location or a quantification of historical occupation of the location during events, as non-limiting examples. In other examples, the historical data that may be used may include historical prices of tickets paid in a primary or secondary market environment.

In some embodiments, the placement of design locations for image capture may be based upon venue specific preferences collected from spectator groups. In some embodiments, venue specific preferences may be collected by surveying spectator groups. In other embodiments, a preference election may be solicited in an interactive manner from spectator groups including in a non-limiting perspective by internet based preference collection mechanisms. A virtual representation of a venue along with the design for a stage or other performance location and historical or designed image capture locations may be utilized in the acquisition of spectator preference collection in some embodiments. One general aspect includes a method of capturing venue specific imagery of an event, the method including the steps of obtaining spatial reference data for a specific venue. The method may also include creating a digital model of the specific venue. The method may also include selecting multiple vantage points for image capture in the specific venue. The method may also include placing two or more of two dimensional image capture devices or three dimensional image capture devices at selected multiple vantage points, where the data is synchronized such that a user may view image data from the multiple vantage points.

Implementations may include one or more of the following features. The method may include the step of presenting the digital model to a first user, where the presentation supports a selecting of multiple vantage points for image capture. The method may also include where the presentation includes venue specific aspects. The method may also include where the venue specific aspects include one or more of seating locations, aisle locations, obstructions to viewing, performance venue layout, sound control apparatus, sound projection apparatus, and lighting control apparatus. The method may also include where the selecting of multiple vantage points is performed by interacting with a graphical display apparatus, where the interacting involves placement of a cursor location and selecting of the location with a user action. The method may also include where the user action includes one or more of clicking a mouse, clicking a switch on a stylus, engaging a keystroke, or providing a verbal command. The method may also include additionally including the step of presenting the digital model to a second user, where the second user employs the presented digital model to locate selected image capture locations in the venue. The method additionally may also include the step of recording image data from selected image capture location. The method may also include utilizing a soundboard to mix collected image data with audio data. The method may also include performing on demand post processing on audio and image data in a broadcast truck. The method may also include the step of communicating data from the broadcast truck utilizing a satellite uplink. The method may also include the step of transmitting at least a first stream of image data to a content delivery network. The method additionally including the step of obtaining venue specific historical data. The method may also include where the venue specific historical data includes one or more parameters relating to primary price, secondary price, frequency of occupation, and rate of purchase. The method may also include where the venue specific historical data is used to create a first graphical layer of the digital model. The method additionally may include a step of choosing image capture locations in the specific venue utilizing a presentation of the first graphical layer. The method may also include where the step of choosing image capture locations in the specific venue utilizing the presentation of the graphical layer is performed automatically. The method additionally may include presenting the digital model to a survey group and collecting preference data from the survey group. The method may also include where the venue specific historical data is used to create a second graphical layer of the digital model. The method additionally including a step of choosing image capture locations in the specific venue utilizing a presentation of the second graphical layer. The method may also include where the step of choosing image capture locations in the specific venue utilizing the presentation of the second graphical layer is performed automatically.

One general aspect includes a method of capturing venue specific imagery of an event, the method including the step of obtaining spatial reference data for a specific venue; creating a digital model of the specific venue. The method may also include presenting the digital model to a first user, where the presentation supports a selecting of multiple vantage points for image capture; selecting multiple vantage points for image capture in the specific venue; placing two or more of two dimensional image capture devices or three dimensional image capture devices at selected multiple vantage points, where the data is synchronized such that a user may view image data from the multiple vantage points; recording image data from selected image capture location, utilizing a soundboard to mix collected image data with audio data, performing on demand post processing on audio and image data in a broadcast truck; and communicating data from the broadcast truck utilizing a satellite uplink. The method may also include transmitting at least a first stream of image data to a content delivery network.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a block diagram of Content Delivery Workflow according to some embodiments of the present invention.

FIG. 2A illustrates the parameters influencing placement of image capture devices in an exemplary stadium venue.

FIG. 2B illustrates the parameters influencing placement of image capture devices in an exemplary big room venue.

FIG. 3 illustrates an exemplary spatial representation of located image capture devices on a venue representation with location information.

FIG. 4 illustrates an exemplary virtual representation at a located image capture device.

FIG. 5 illustrates exemplary venue specific aspects and features that may relate to some embodiments of the present invention.

FIG. 6 illustrates an exemplary flow diagram according to some embodiments of the present invention.

FIG. 7 illustrates an additional exemplary flow diagram according to some embodiments of the present invention.

FIG. 8 illustrates apparatus that may be used to implement aspects of the present invention including executable software.

### DETAILED DESCRIPTION

The present invention provides generally for the use of multiple camera arrays for the capture and processing of image data that may be used to generate visualizations of live performance imagery from a multi-perspective reference. More specifically, the visualizations of the live performance imagery can include oblique and/or orthogonal approaching and departing view perspectives for a performance setting. Image data captured via the multiple camera arrays is synchronized and made available to a user via a communications network. The user may choose a viewing vantage point from the multiple camera arrays for a particular instance of time or time segment.

In the following sections, detailed descriptions of embodiments and methods of the invention will be given. The description of both preferred and alternative embodiments though through are exemplary only, and it is understood that to those skilled in the art that variations, modifications and alterations may be apparent. It is therefore to be understood that the exemplary embodiments do not limit the broadness of the aspects of the underlying invention as defined by the claims.

### DEFINITIONS

As used herein “Broadcast Truck” refers to a vehicle transportable from a first location to a second location with electronic equipment capable of transmitting captured image data, audio data and video data in an electronic format, wherein the transmission is to a location remote from the location of the Broadcast Truck.

As used herein, “Image Capture Device” refers to apparatus for capturing digital image data, an Image capture device may be one or both of: a two dimensional camera (sometimes referred to as “2D”) or a three dimensional camera (sometimes referred to as “3D”). In some exemplary embodiments an image capture device includes a charged coupled device (“CCD”) camera.

As used herein, Production Media Ingest refers to the collection of image data and input of image data into storage for processing, such as Transcoding and Caching. Production Media Ingest may also include the collection of associated data, such a time sequence, a direction of image capture, a viewing angle, 2D or 3D image data collection.

As used herein, Vantage Point refers to a location of Image Data Capture in relation to a location of a performance.

As used herein, Directional Audio refers to audio data captured from a vantage point and from a direction such that the audio data includes at least one quality that differs from audio data captured from the vantage and a second direction or from an omni-direction capture.

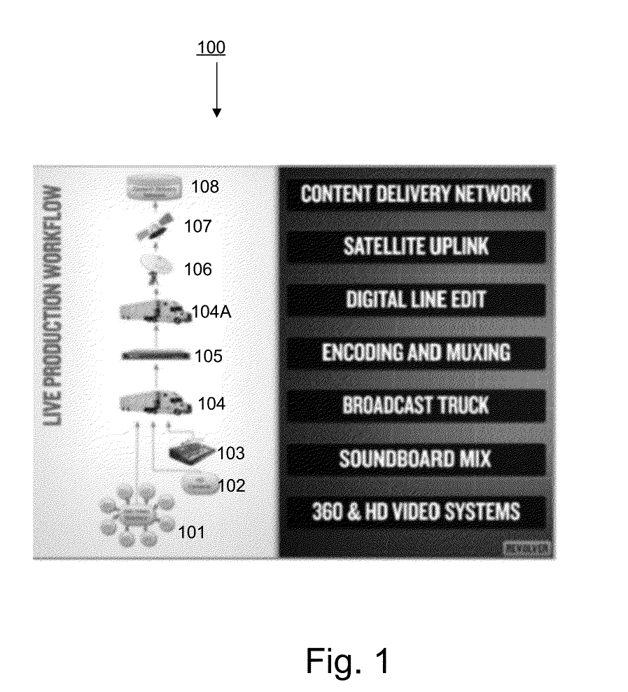

Referring now to FIG. 1, a Live Production Workflow diagram is presented 100 with components that may be used to implement various embodiments of the present invention. Image capture devices 101-102, such as for example, one or both of 360 degree camera arrays 101 and high definition camera's 102 capture image date of an event. In preferred embodiments, multiple vantage points each have both a 360 degree camera array 101 and at least one high definition camera 102 capturing image data of the event. Image capture devices 101-102 may be arranged for one or more of: planer image data capture; oblique image data capture; and perpendicular image data capture. Some embodiments may also include audio microphones to capture sound input which accompanies the captured image data.

Additional embodiments may include camera arrays with multiple viewing angles that are not complete 360 degree camera arrays, for example, in some embodiments, a camera array may include at least 120 degrees of image capture, additional embodiments include a camera array with at least 180 degrees of image capture; and still other embodiments include a camera array with at least 270 degrees of image capture. In various embodiments, image capture may include cameras arranged to capture image data in directions that are planar or oblique in relation to one another.

At 103, a soundboard mix may be used to match recorded audio data with captured image data. In some embodiments, in order to maintain synchronization, an audio mix may be latency adjusted to account for the time consumed in stitching 360 degree image signals into cohesive image presentation.

At 104, a Broadcast Truck includes audio and image data processing equipment enclosed within a transportable platform, such as, for example, a container mounted upon, or attachable to, a semi-truck, a rail car; container ship or other transportable platform. In some embodiments, a Broadcast Truck will process video signals and perform color correction. Video and audio signals may also be mastered with equipment on the Broadcast Truck to perform on-demand post-production processes.

At 105, in some embodiments, post processing may also include one or more of: encoding; muxing and latency adjustment. By way of non-limiting example, signal based outputs of HD cameras may be encoded to predetermined player specifications. In addition, 360 degree files may also be re-encoded to a specific player specification. Accordingly, various video and audio signals may be muxed together into a single digital data stream. In some embodiments, an automated system may be utilized to perform muxing of image data and audio data.

At 104A, in some embodiments, a Broadcast Truck or other assembly of post processing equipment may be used to allow a technical director to perform line-edit decisions and pass through to a predetermined player's autopilot support for multiple camera angles.

At 106, a satellite uplink may be used to transmit post process or native image data and audio data. In some embodiments, by way of non-limiting example, a muxed signal may be transmitted via satellite uplink at or about 80 megabytes (Mb/s) by a commercial provider, such as, PSSI Global™ or Sureshot™ Transmissions.

In some venues, such as, for example events taking place at a sports arena a transmission may take place via Level 3 fiber optic lines, otherwise made available for sports broadcasting or other event broadcasting. At 107 Satellite Bandwidth may be utilized to transmit image data and audio data to a Content Delivery Network 108.

As described further below, a Content Delivery Network 108 may include a digital communications network, such as, for example, the Internet. Other network types may include a virtual private network, a cellular network, an Internet Protocol network, or other network that is able to identify a network access device and transmit data to the network access device. Transmitted data may include, by way of example: transcoded captured image data, and associated timing data or metadata.

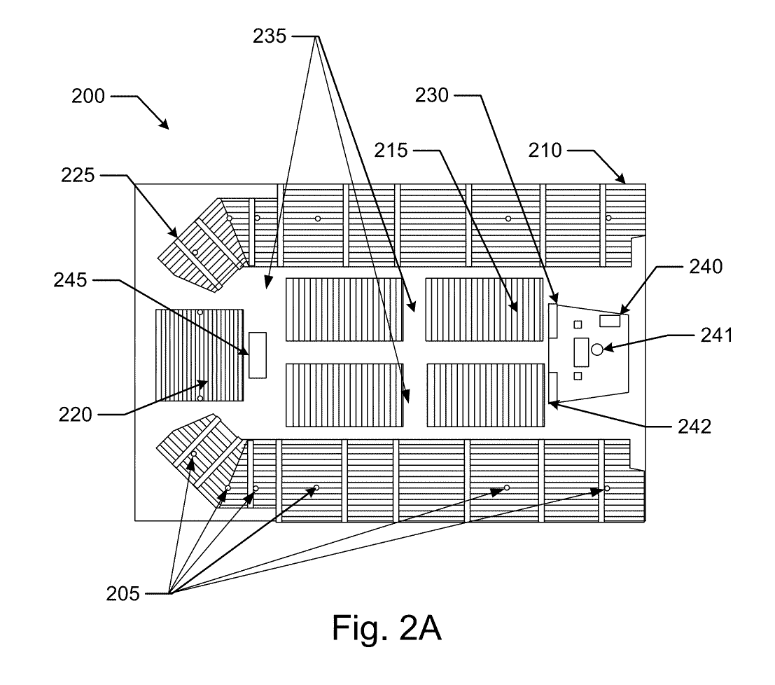

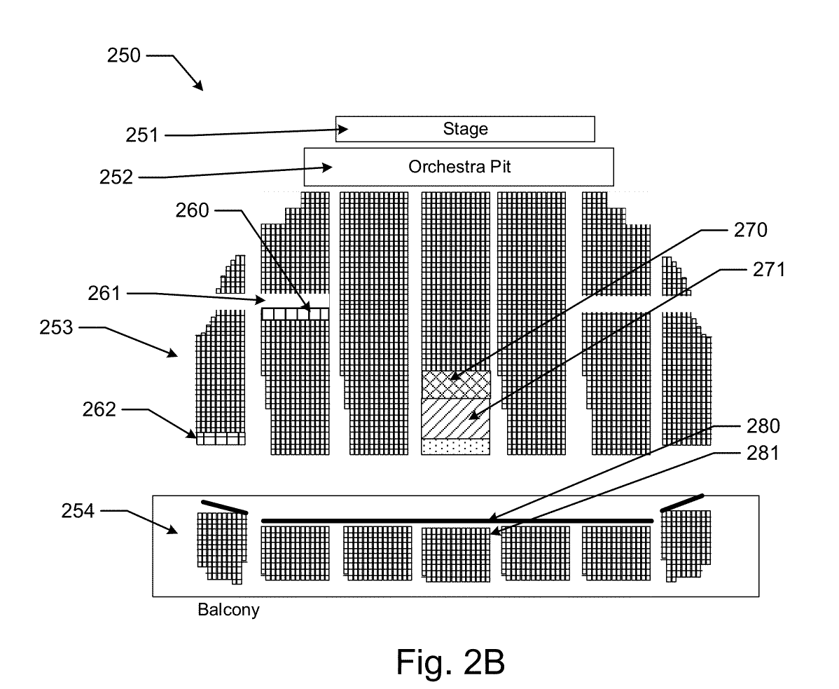

Referring to FIGS. 2A and 2B, the placement of image capture devices may be illustrated for exemplary venues 200 and 250. The differences in the design of the two venues may be observed in reference to the top down design depictions. In a general perspective the types of venues may vary significantly and may include rock clubs, big rooms, amphitheaters, dance clubs, arenas and stadiums as non-limiting examples.

At exemplary venue 200 a depiction of a stadium venue may be found. A stadium may include a large collection of seating locations of various different types. There may be seats such as those surrounding region 215 that have an unobstructed close view to the performance venue 230 which may be called the stage or other performance venue. Other seats such as region 210 may have a side view of the stage or performance venue 230. Some seating locations such as region 225 may have obstructions including the location of other seating regions. At 220, a region may occur that is located behind and in some cases obstructed by venue control locations such as sound and lighting control systems 245. The venue may also have aisles such as 235 where pedestrian traffic may create intermittent obstruction to those seating locations there behind.

In some embodiments, the location of recording devices may be designed to include different types of seating locations. There may be aspects of a stadium venue that may make a location undesirable as a design location for image capture. At locations 205 numerous columns are depicted that may be present in the facility. There may be other such features that may be undesirable planned image capture locations such as behind handicap access, behind aisles with high foot traffic, or in regions where light or other external interruptive aspects may obscure image capture.

The stage or performance venue 230 may have numerous aspects that affect image collection. In some examples, the design of the stage may place performance specific effects on a specific venue. For example, the placement of speakers, such as that at location 242 may impact the view conditions for some spectator regions. The presence of performance equipment such as, in a non-limiting sense, drum equipment 241 may also create different aspects of viewing. There may be sound control and other performance related equipment on stage such as at 240 that may create specific view considerations. It may be apparent that each venue may have specific aspects that differ from other venues even of the same type, and that the specific stage or performance layout may create performance specific aspects in addition to the venue specific aspects.

A stadium venue may have rafters and walkways at elevated positions. In some embodiments such elevated locations may be used to support or hang image capture devices from. In some embodiments, apparatus supported from elevated support positions such as rafters may be configured to capture image data while moving.

At exemplary venue 260 in FIG. 2B, a depiction of a big room venue may be found. As mentioned there are numerous types of different venues, a big room demonstrates how some fundamental aspects may differ between choices of optimal image capture locations. In an exemplary sense, a big room may typically lack obstructive features such as columns and many types of railings. From a different perspective, the seats in a big room may not have the amount of elevation present in a stadium setting and, therefore, may quickly have obstructive aspects of the spectator population. As well, the presence of an image capture apparatus may itself create more interruptions in the flatter setting of a big room to spectators. Referring again to FIG. 2B, in a big room at 260 there may be regions that have relatively obstructed views due to the movement of pedestrians in aisles such as 261. There may also be a sound and lighting control area such as item 270 which impact viewing conditions at region 271 in an exemplary sense. In some embodiments, the locations behind such sound and control regions may have relatively significant amounts of obstruction. On the other hand, the sound and lighting aspects of the production may have optimal characteristics in regions close to control locations. These factors may create regions in a particular venue that are planned or unplanned for image capture.

In some embodiments, a big room venue may have a stage 251 with a neighboring Orchestra pit 252. There may also be special seating locations such as at 262 which for example may be a handicap seating location that may cause consideration of viewing aspects. These various locations may occur in a first level 253 that in some embodiments may be termed an orchestra level. The venue may have one or more elevated seating regions such as a balcony region at 254 as an example. Due to the elevated aspect of region 254, there may be railings and walls such as at 280 that create viewing aspects for seating locations such as at 281. The elevation of a balcony may move a spectator some distance away from a stage or performance location; however, on the other hand, it may provide a unique perspective on performance viewing as well due to the elevated perspective. These factors may have a role in determining the design locations for image capture apparatus according to the inventive art herein.

It may be apparent that specific venues of a particular venue type may have different characteristics relevant to the placement of image capture apparatus. It may be further apparent that different types of venues may also have different characteristics relevant to the placement of image capture apparatus. In some embodiments, the nature and location of regions in a specific venue may be characterized and stored in a repository. In some embodiments, the venue characterization may be stored in a database. The database may be used by algorithms to present a display of a seating map of a specific venue along with characteristics that may be positive or negative for the venue. In some embodiments, the display may be made via a graphical display station connected to a processor.

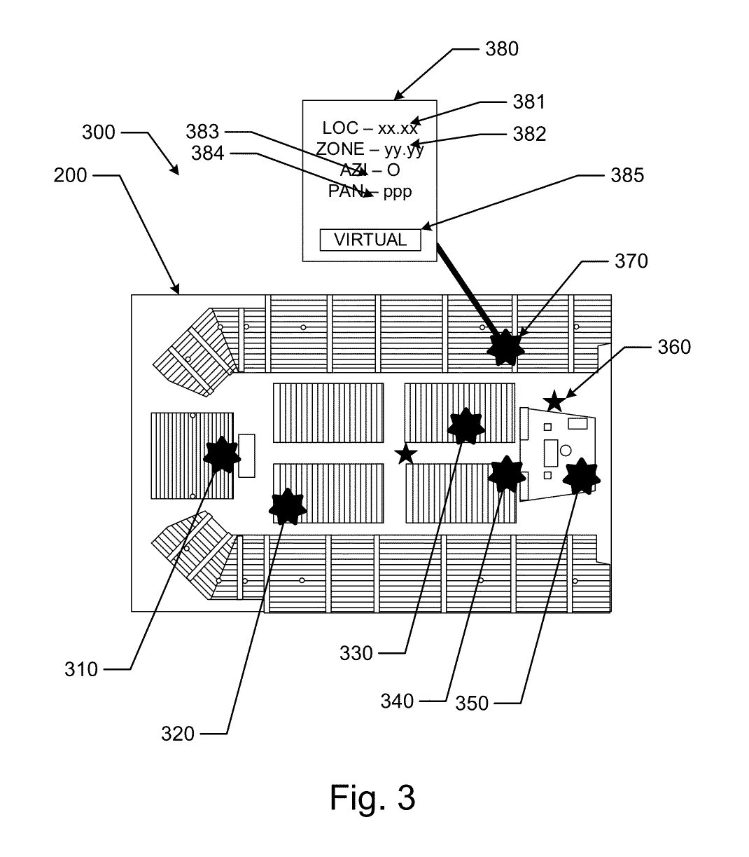

Referring to FIG. 3 item 300, a representation of a specific exemplary venue as demonstrated at 200 that may be presented to a viewer may be found where specific designed regions relating to image capture may be indicated therein, such as the star at 310. The star at 310 may represent a particular camera type being located proximate to a sound control region as previously discussed. In addition, in an exemplary fashion there may be representations (such as the difference between a star at 360 and a star of the type at 310 that may indicate the different type of image capture apparatus at the location. The stars at locations 310, 320, 330, 340, 350 and 370 may represent exemplary 360 degree Camera Arrays and 360 may represent an exemplary High Definition Camera in a non-limiting example. In some embodiments, the presentation may be made in a manner that allows the user to interact with the defined locations by actions such as clicking a button while a cursor is located over an element of interest such as one of these stars, or by the action of moving the cursor over the element of interest as well.

At the star at location 370, an example of a menu presentation at 380 that may be included in the graphical representation of the venue design may be found. There may be other examples of venue specific items that may be displayed and may have activity upon selecting them. For example, active points for viewer interaction may include columns, stage sets, positions of performers, entrances and exits, layout of venue seating, elevations of venue seating, multi-level venue seating, and changes in venue layout for specific events.

Referring still to FIG. 3, the representation of each of the highlighted aspects of a venue may include a feature where a virtual representation of the element may be presented to the user. In some exemplary embodiments, when an active element is activated by a means, the display of relevant data associated with the element may be presented to the user as depicted at menu 380. Included in the display of associated information relating to the element may be an active element that may allow for virtual representations of the view aspects of the highlighted location may be found at 385. The type of data that may be included in the menu presentation to the viewer may be large and flexible and in a non-limiting exemplary sense may include positional reference data 381, elevation 382, angular data for such representations as azimuthal 383 and rotational references 384 and other reference data including for example a unique hashtag reference to the location that may be useful for communication of a location in media, or social media as examples.

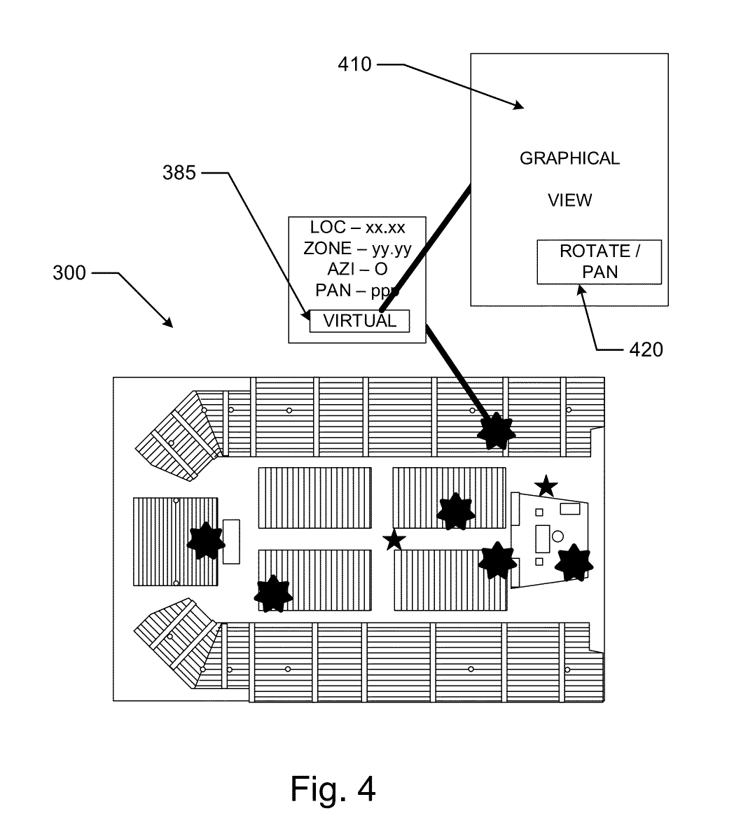

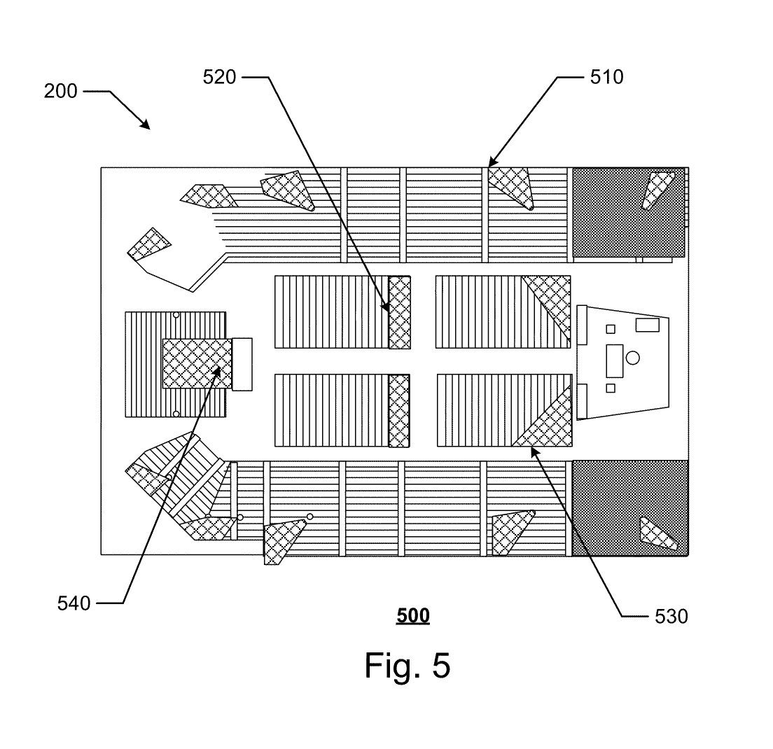

If a user activates the virtual representation element at 385, in some embodiments a display of a virtual representation of the view aspects at the element may be displayed. Referring to FIG. 4, in some embodiments the virtual representation of the location may include an image display of the view 410. In other embodiments, the representation may be a computer generated depiction of the view from a location. In still further embodiments the depiction may include a pictorial representation of the view upon which a computer generated representation of the stage or specific performance venue from the point of interest may be superimposed. At 420, in some embodiments and for some view related data there may be a function to rotate or pan the view representation from the point of interest. For those embodiments that contain social media reference identification, images or textual descriptions from internet or social media sources of the point of interest may be displayed. Referring to FIG. 5, at 500 another depiction of the exemplary venue 200 may be found where obstructed vision locations may be highlighted in a view. For example at item 510 viewing locations that may be obstructed at least in part by columns may be represented. At 520, viewing locations that may be obstructed by aisle traffic may be represented. At 530 viewing locations that may be obstructed by stage equipment such as speaker systems may be represented. And at 540, in an exemplary sense those viewing locations that may be obstructed by personnel and equipment related to sound and lighting control as well as other control functions may be represented. Such a view as that depicted at 500 may be included in a standard representation of a specific venue for a specific stage or performance location layout. In some other embodiments, such a view as that depicted at 500 may be presented upon a selection from a user.

In some embodiments, the visual representation of the specific venue which may also include a representation of a specific stage or other performance venue may be superimposed with graphical depiction of historical data related to the venue. In some embodiments such a representation may aid in a process of designing image capture locations for a future spectator event. There may be a large amount of historical data relating to a venue that may be useful. The process of designing the camera location may include accessing historical data which may be parsed into location specific data elements. As a non-limiting example, the frequency of occupation of locations within the venue may be depicted with color shadings representing frequency ranges. A designer may in some embodiments pick one or more locations based on the highest frequency of occupation as a non-limiting example. A similar type of process may result in an exemplary sense, where the historical data based on time to sale for a location may be used. Still further embodiments may result when ticket prices paid on primary or secondary markets are analyzed and displayed for their location dependence at a particular venue. There may be numerous other types of historical data that may be used in the processing of designing and selecting venue specific image capture locations.

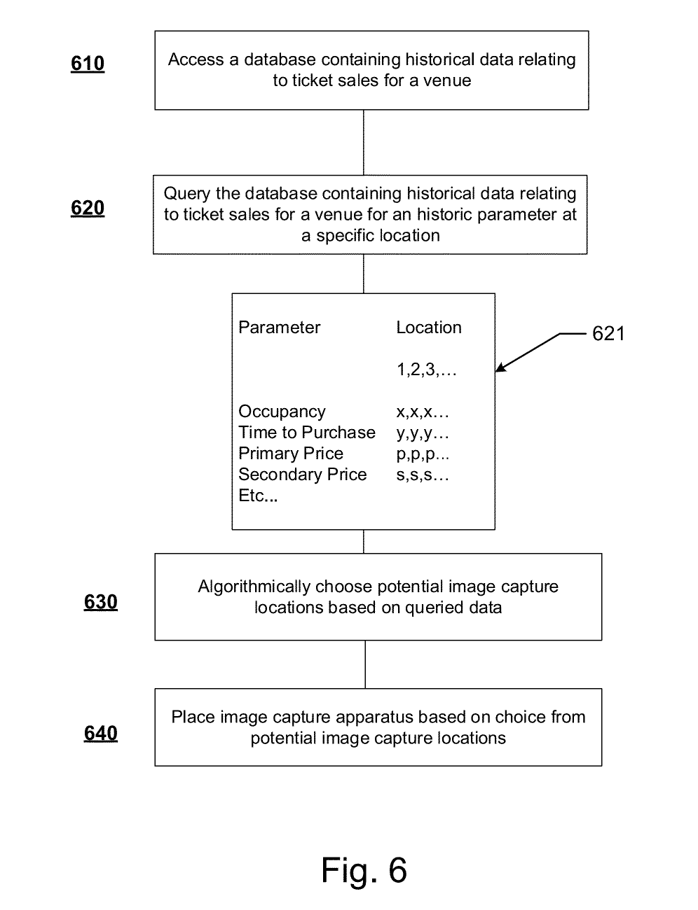

Referring to FIG. 6 a depiction of an exemplary process flow for the design of venue specific image capture locations may be found. At 610, a database containing historical data relating to ticket sales for a specific venue may be accessed. The database may be subjected to a query protocol to extract desired historical data for an historic parameter or parameters at a specific location. The query protocol may in some embodiments be performed for all locations in a venue, in other examples select sections may be queried. In an exemplary sense, at 621 a database subset for queried parameter may be summarized for a particular location. In the example there may be data for a position related to occupancy, time to purchase, price at a primary transaction and price at a secondary transaction. At 630, the data may be displayed and used to algorithmically choose potential image capture locations. In other flows not depicted, a user may view a depiction of database values for select positions to manually perform a choice for image capture locations. At step 640 image capture apparatus may be placed at chosen specific venue locations.

In some alternative embodiments, the depiction of venue specific characteristics and aspects according to the descriptions that have been given may be used to solicit potential users of the event imagery for their preference of image capture locations. In a non-limiting sense, the graphical depiction of the venue specific aspect may be used as an input vehicle. In some embodiments, a specific location may be chosen by the user by various means including clicking a button when a cursor is location at the desired location. The user may be queried for numerous types of preference elections. In some embodiments, the user may indicate a positive or negative preference for image capture at a particular location or a range thereof. The type of image capture devices available may also be queried for preference. As well characteristics of the image capture including for example the focal characteristics of the image, such as focusing on a particular performer or a particular location in the performance area or in the spectator locations may be queried. In some embodiments, the collection of user preference may be performed in a proactive manner. In other embodiments, some of the relevant information may be collected during an active event at a specific venue for a specific performance.

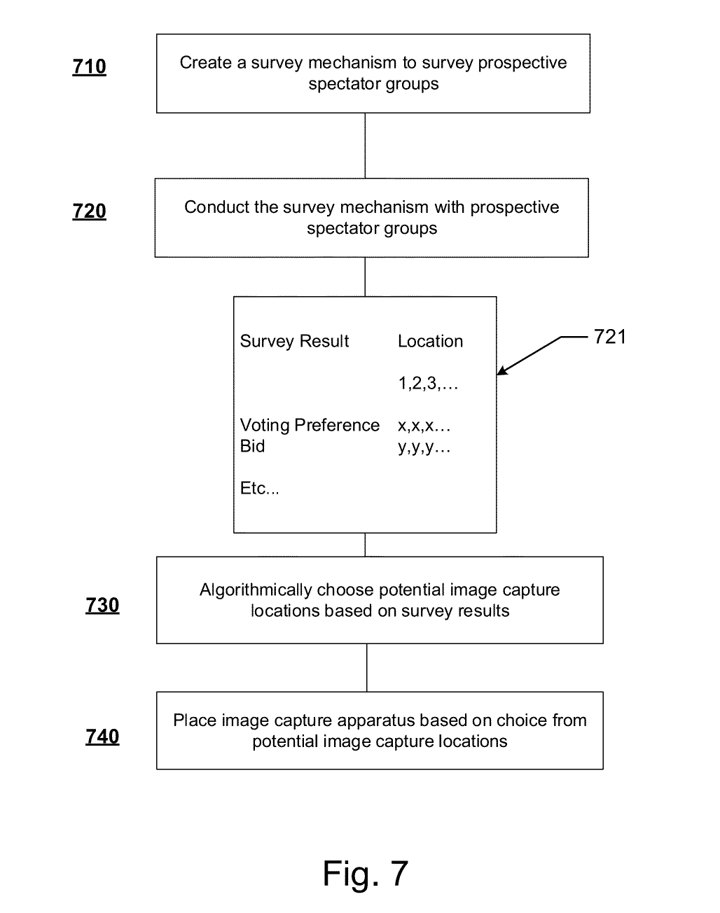

Referring to FIG. 7, a depiction of steps in a process flow to design image capture may be found. At step 710 a survey mechanism to survey prospective spectator groups may be created. At step 720, the survey may be conducted and may generate a dataset containing a survey result such as a preference indication or a bid value as examples on a representation by location in the specific venue. At step 730, an algorithm may be used to choose potential image capture locations based on the survey results in the dataset. In other flows not depicted, a user may view a depiction of the survey database values for select positions to manually perform a choice for image capture locations. At step 740 image capture apparatus may be placed at chosen specific venue locations.

Apparatus

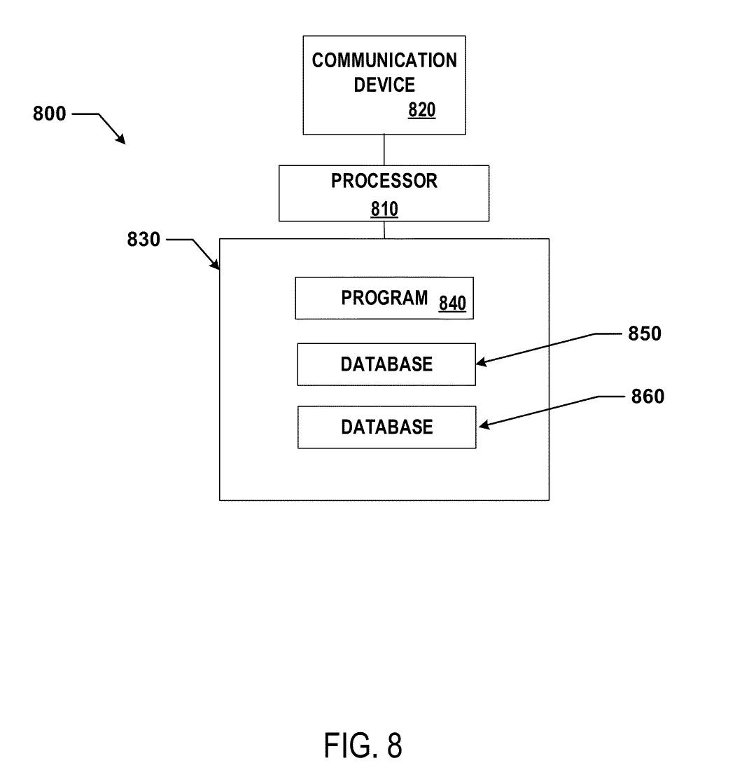

In addition, FIG. 8 illustrates a controller 800 that may be utilized to implement some embodiments of the present invention. The controller may be included in one or more of the apparatus described above, such as the Revolver Server, and the Network Access Device. The controller 800 comprises a processor unit 810, such as one or more semiconductor based processors, coupled to a communication device 820 configured to communicate via a communication network (not shown in FIG. 8). The communication device 820 may be used to communicate, for example, with one or more online devices, such as a personal computer, laptop or a handheld device.

The processor 810 is also in communication with a storage device 830. The storage device 830 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 830 can store a software program 840 for controlling the processor 810. The processor 810 performs instructions of the software program 840, and thereby operates in accordance with the present invention. The processor 810 may also cause the communication device 820 to transmit information, including, in some instances, control commands to operate apparatus to implement the processes described above. The storage device 830 can additionally store related data in a database 850 and database 860, as needed.

Specific Examples of Equipment

Apparatus described herein may be included, for example in one or more smart devices such as, for example: a mobile phone, tablet or traditional computer such as laptop or microcomputer or an Internet ready TV.

The above described platform may be used to implement various features and systems available to users. For example, in some embodiments, a user will provide all or most navigation. Software, which is executable upon demand, may be used in conjunction with a processor to provide seamless navigation of 360/3D/panoramic video footage with Directional Audio—switching between multiple 360/3D/panoramic cameras and user will be able to experience a continuous audio and video experience.

Additional embodiments may include the system described automatic predetermined navigation amongst multiple 360/3D/panoramic cameras. Navigation may be automatic to the end user but the experience either controlled by the director or producer or some other designated staff based on their own judgment.

Still other embodiments allow a user to participate in the design and placement of imaging recording equipment for a specific performance at a specific venue. Once the image capture apparatus is positioned and placed in use a user may record a user defined sequence of image and audio content with navigation of 360/3D/panoramic video footage, Directional Audio, switching between multiple 360/3D/panoramic cameras. In some embodiments, user defined recordations may include audio, text or image data overlays. A user may thereby act as a producer with the Multi-Vantage point data, including directional video and audio data and record a User Produced multimedia segment of a performance. The User Produced may be made available via a distributed network, such as the Internet for viewers to view, and, in some embodiments further edit the multimedia segments themselves.

Directional Audio may be captured via an apparatus that is located at a Vantage Point and records audio from a directional perspective, such as a directional microphone in electrical communication with an audio storage device. Other apparatus that is not directional, such as an omni directional microphone may also be used to capture and record a stream of audio data; however such data is not directional audio data. A user may be provided a choice of audio streams captured from a particular vantage point at particular time in a sequence.

In some embodiments a User may have manual control in auto mode. The User is able to manually control by actions such as swipe or equivalent to switch between MVPs or between HD and 360. In still further embodiments, a user may interact with a graphical depiction of a specific venue where image capture elements have been indicated thereupon.

In some additional embodiments, an Auto launch Mobile Remote App may launch as soon as video is transferred from iPad to TV using Apple Airplay. Using tools, such as, for example, Apple's Airplay technology, and a user may stream a video feed from iPad or iPhone to a TV which is connected to Apple TV. When a user moves the video stream to TV, automatically mobile remote application launches on iPad or iPhone is connected/synched to the system. Computer Systems may be used to displays video streams and switches seamlessly between 360/3D/Panoramic videos and High Definition (HD) videos.

In some embodiments that implement Manual control, executable software allows a user to switch between 360/3D/Panoramic video and High Definition (HD) video without interruptions to a viewing experience of the user. The user is able to switch between HD and any of the multiple vantage points coming as part of the panoramic video footage.

In some embodiments that implement Automatic control a computer implemented method (software) that allows its users to experience seamlessly navigation between 360/3D/Panoramic video and HD video. Navigation is either controlled a producer or director or a trained technician based on their own judgment.

Manual Control and Manual Control systems may be run on a portable computer such as a mobile phone, tablet or traditional computer such as laptop or microcomputer. In various embodiments, functionality may include: Panoramic Video Interactivity, Tag human and inanimate objects in panoramic video footage; interactivity for the user in tagging humans as well as inanimate objects; sharing of these tags in real time with other friends or followers in your social network/social graph; Panoramic Image Slices to provide the ability to slice images/photos out of Panoramic videos; real time processing that allows users to slice images of any size from panoramic video footage over a computer; allowing users to purchase objects or items of interest in an interactive panoramic video footage; ability to share panoramic images slides from panoramic videos via email, sms (smart message service) or through social networks; share or send panoramic images to other users of a similar application or via the use of SMS, email, and social network sharing; ability to “tag” human and inanimate objects within Panoramic Image slices; real time “tagging” of human and inanimate objects in the panoramic image; allowing users to purchase objects or items of interest in an interactive panoramic video footage; content and commerce layer on top of the video footage—that recognizes objects that are already tagged for purchase or adding to user's wish list; ability to compare footage from various camera sources in real time; real time comparison panoramic video footage from multiple cameras captured by multiple users or otherwise to identify the best footage based on aspects such as visual clarity, audio clarity, lighting, focus and other details; recognition of unique users based on the user's devices that are used for capturing the video footage (brand, model #, MAC address, IP address, etc.); radar navigation of which camera footage is being displayed on the screens amongst many other sources of camera feeds; navigation matrix of panoramic video viewports that in a particular geographic location or venue; user generated content that can be embedded on top of the panoramic video that maps exactly to the time codes of video feeds; time code mapping done between production quality video feed and user generated video feeds; user interactivity with the ability to remotely vote for a song or an act/song while watching a panoramic video and effect outcome at venue. Software allows for interactivity on the user front and also ability to aggregate the feedback in a backend platform that is accessible by individuals who can act on the interactive data; ability to offer “bidding” capability to panoramic video audience over a computer network, bidding will have aspects of gamification wherein results may be based on multiple user participation (triggers based on conditions such # of bids, type of bids, timing); Heads Up Display (HUD) with a display that identifies animate and inanimate objects in the live video feed wherein identification may be tracked at an end server and associated data made available to front end clients.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

1. A method of capturing venue specific imagery of an event, the method comprising the steps of:
obtaining spatial reference data for a specific venue;
creating a digital model of the specific venue;
selecting multiple vantage points for image capture in the specific venue; and
placing two or more of two dimensional image capture devices or three dimensional image capture devices at selected multiple vantage points, wherein the data is synchronized such that a user may view image data from the multiple vantage points.

2. The method of claim 1 additionally comprising the steps of:
presenting the digital model to a first user, wherein the presentation supports a selecting of multiple vantage points for image capture.

3. The method of claim 2 wherein the presentation includes venue specific aspects.

4. The method of claim 3 wherein the venue specific aspects include one or more of seating locations, aisle locations, obstructions to viewing, performance venue layout, sound control apparatus, sound projection apparatus, and lighting control apparatus.

5. The method of claim 4 wherein the selecting of multiple vantage points is performed by interacting with a graphical display apparatus, wherein the interacting involves placement of a cursor location and selecting of the location with a user action.

6. The method of claim 5 wherein the user action includes one or more of clicking a mouse, clicking a switch on a stylus, engaging a keystroke, or providing a verbal command.

7. The method of claim 3 additionally comprising the step of presenting the digital model to a second user, wherein the second user employs the presented digital model to locate selected image capture locations in the venue.

8. The method of claim 7 additionally comprising the steps of:
recording image data from selected image capture location;
utilizing a soundboard to mix collected image data with audio data; and
performing on demand post processing on audio and image data in a broadcast truck.

9. The method of claim 8 additionally comprising the step of:
communicating data from the broadcast truck utilizing a satellite uplink.

10. The method of claim 9 additionally comprising the step of:
transmitting at least a first stream of image data to a content delivery network.

11. The method of claim 2 additionally comprising the step of:
obtaining venue specific historical data.

12. The method of claim 11 wherein the venue specific historical data comprises one or more parameters relating to primary price, secondary price, frequency of occupation, and rate of purchase.

13. The method of claim 12 wherein the venue specific historical data is used to create a first graphical layer of the digital model.

14. The method of claim 13 additionally comprising a step of:
choosing image capture locations in the specific venue utilizing a presentation of the first graphical layer.

15. The method of claim 14 wherein the step of choosing image capture locations in the specific venue utilizing the presentation of the graphical layer is performed automatically.

16. The method of claim 12 additionally including presenting the digital model to a survey group and collecting preference data from the survey group.

17. The method of claim 16 wherein the venue specific historical data is used to create a second graphical layer of the digital model.

18. The method of claim 17 additionally comprising a step of:
choosing image capture locations in the specific venue utilizing a presentation of the second graphical layer.

19. The method of claim 18 wherein the step of choosing image capture locations in the specific venue utilizing the presentation of the second graphical layer is performed automatically.

20. A method of capturing venue specific imagery of an event, the method comprising the steps of:
obtaining spatial reference data for a specific venue;
creating a digital model of the specific venue;
presenting the digital model to a first user, wherein the presentation supports a selecting of multiple vantage points for image capture;
selecting multiple vantage points for image capture in the specific venue;
placing two or more of two dimensional image capture devices or three dimensional image capture devices at selected multiple vantage points; wherein the data is synchronized such that a user may view image data from the multiple vantage points;
recording image data from selected image capture location;
utilizing a soundboard to mix collected image data with audio data;
performing on demand post processing on audio and image data in a broadcast truck;
communicating data from the broadcast truck utilizing a satellite uplink; and
transmitting at least a first stream of image data to a content delivery network.
